(19) United States
(12) Patent Application Publication
(10) Pub. No.: US 2010/0129489 A1
(43) Pub. Date: May 27, 2010

(54) SENSATE-PLATED SANDING COMPOSITION AND PRODUCTS MADE THEREFROM

(76) Inventors: Bharani Ashokan, McKinney, TX (US); Joan E. Harvey, Morgantown, PA (US); Georgina Louise Perry, Hoboken, NJ (US); Khyati A. Valand, Flanders, NJ (US)

Correspondence Address: CANTOR COLBURN, LLP, 20 Church Street, 22nd Floor, Hartford, CT, 06103, US

(21) Appl. No.: 12/616,158

(22) Filed: Nov. 11, 2009

Related U.S. Application Data
(60) Provisional application No. 61/113,869, filed on Nov. 12, 2008.

(51) Int. Cl. A23G 4/08; A23G 3/36; A23G 3/54; A23L 1/22

(52) U.S. Cl. 426/5; 426/103; 426/294; 426/293

(57) ABSTRACT

The present invention relates to sensate-plated sanding compositions, products containing the same and methods for preparing. More specifically, the compositions of the present invention may include a particulate and a sensate composition, which may include a flavor and/or functional component, associated with the particulate.

### CROSS REFERENCE TO RELATED APPLICATION

This application claims the benefit of U.S. Provisional Application Ser. No. 61/113,869 filed Nov. 12, 2008, which is hereby incorporated by reference in its entirety.

### FIELD

The present invention is directed generally to coating compositions and products containing the same. More particularly, the present invention relates to coating compositions including a sanding composition that includes particulates and a sensate composition associated with the sanding composition.

### BACKGROUND

Various coatings may be added to confectionery and chewing gum compositions in order to provide additional colors, flavors, and textures. Such coatings in particulate form may be applied to the surface of confectioneries, such as gummy candies and chewy candies, in order to provide a desired organoleptic effect.

However, sensate agents, such as cooling, warming and tingling agents, typically have relatively high volatility. When used as coatings, much of the sensate agent volatizes during manufacture or storage. Thus, the consumer does not receive the full benefit of their impact on the organoleptic perceptions and attendant enhancements to the overall product.

As a result of such high volatility, sensates and/or flavors are typically used in encapsulated forms, such as, spray drying or other means of entrapping and/or converting the liquids into solid form, to minimize volatility loss. Encapsulation forms, however, do not give a rapid or instant onset of the sensate or flavor.

It would be beneficial to provide compositions which overcome such volatility obstacles and which allow for an enhanced organoleptic perception in the final product.

### SUMMARY

In some embodiments, there is provided a sensate-plated sanding composition that includes a saccharide particulate plated with a liquid sensate composition.

In some embodiments, there is provided a multi-region, sensate-plated sanded confectionery composition including a first region including a confectionery base composition; and a second region including a saccharide particulate and a liquid sensate composition associated with the saccharide particulate, where the second region at least partially surrounds the first region.

In some embodiments, there is provided a method of making a sensate-plated sanded confectionery composition including the steps of providing a confectionery base composition having an outer surface; providing a sensate-plated sanding composition; steaming the outer surface of the confectionery base composition; and applying the sensate-plated sanding composition to the outer surface of the confectionery base composition.

In some embodiments, there is provided a method of preparing a coated confectionery product including the steps of: applying a liquid wetting syrup to a surface of a confectionery base composition to form a wetted confectionery composition; forming a tacky exterior surface on the wetted confectionery composition by drying or removing at least a portion of the liquid from the confectionery surface; applying a sensate-plated sanding composition to the tacky exterior surface to form a sensate-plated sanded confectionery composition; further drying the sensate-plated sanded confectionery composition; and packaging the dried sensate-plated sanded confectionery composition.

### DETAILED DESCRIPTION

In some embodiments a sensate-plated sanding composition is provided that includes a saccharide particulate plated with at least one liquid sensate composition. One advantage of plating the particulate with the liquid sensate composition is that it provides a significantly higher sensate perception, i.e., warming, tingling or cooling perception, on initial impact than encapsulated particulate forms of liquid sensates, such as a spray dried sensates.

Another advantage of plating saccharide particulates with liquid sensates is a faster onset of perception of the sensate. In some embodiments, sorption of the liquid sensates into and/or onto the particles allows for lower loading of the sensate, yet may provide the user with a higher initial impact upon consumption. The enhanced sensate perception is believed to be at least in part due to the fact that the plated sensate and/or flavor component is more immediately available to sensory perception and thus can achieve a higher impact with lesser amounts of sensate than traditional encapsulation methods. In some embodiments, higher availability of the sensate, coupled with less loss due to volatilization, oxidation or other undesired reactions, allows for a higher impact of the sensate to reach the mouth of the user. Additionally, sanding particulates on the surface of the confectionery offer increased surface area for exposure of the sensate-plated compositions to the oral cavity, thereby increasing the perceived effect of the sensate composition, and allowing for lower amounts to be used to achieve a higher sensate perception. Quite unexpectedly, plating of sanding compositions did not suffer from the disadvantages of prior methods of incorporating sensates and/or flavors with confections and chewing gums.

The term “confection”, or “confectionery” or “confectionery base” may include any conventional confectionary composition, such as gummy candy or “gummi” confections (gummy candy includes a hydrocolloid texturizing agent such as gelatin alone or in combination with other texturizing agents). Also included in those chewable forms are soft candies such as, but not limited to, gum drops, licorice, fruit snacks, starch based jellies, gelatin based jellies, pectin based jellies, carageenan based jellies, agar based jellies, konjac based jellies, chewy candy, starch candy, nougat, toffee, taffy, marshmallow, fondant, fudge, chocolate, compound coating, carob coating, caramel, compressed tablets, candy floss (also known as cotton candy), marzipan, hard boiled candy, nut brittles, pastilles, pralines, nonpareils, dragees, lozenges, sugared nuts, comfits, aniseed balls, nougatine, and jelly beans. Also included in those chewable forms are chewing gums including bubble gums. In some embodiments, the confectionery base is selected from the group consisting of chewy candy, gummy candy, marshmallow, chewing gum, and combinations thereof.

The basis of gummy confections is generally a sugar/glucose syrup or a polyol/polyol syrup or sugar/polyol combination and a gelatinizing agent, the latter of which may be gelatin, agar, gum arabic, maltodextrin, pectin, carageenan, konjac, modified starches or combinations thereof. Various other gums (also referred to as hydrocolloids) may also be used. The gelatinizing material may be desirably dissolved in water or otherwise hydrated prior to mixing with the sugar/glucose syrup combination. If a hydrocolloid such as pectin is used as the gelatinizing agent, then the pectin is desirably dry mixed with a portion of the sugar or bulk sweetener prior to addition of the dry mixture to water.

As used herein, the term “gum region” or “confectionery region” refers to a region of a multi-region gum or confectionery product, respectively, that may be adjacent to or at least partially surrounding a center-fill, or innermost, region. In some embodiments, the gum region or confectionery region is an intermediate region.

As used herein, the term “center-fill” refers to the innermost region of a center-fill gum or confectionery product. In some embodiments, the center-fill region is at least partially surrounded by the confectionery base region. The term “center-fill” does not necessarily imply symmetry of a gum or confectionery product, only that the “center-fill” is within another region of the product. In some embodiments, the center-fill may be substantially symmetric and in others, the center-fill may not be symmetric of the chewing gum or confectionery piece. In some embodiments, more than one center-fill may be present. A center-fill may include solid, liquid, gas and mixtures thereof. The term “liquid” in the context of a center-fill includes fluid materials as well as semi-solid or gel materials. The center-fill can be aqueous, non-aqueous, or an emulsion.

As used herein, the terms “coating” or “coating region” are used to refer to the outermost region of a multi-region confectionery product. Particulate coatings may be referred to as sanding compositions or dusting compositions. Confections with such particulate coatings may be referred to as being sanded or dusted.

The term “tacky” is used to mean that the surface of the material is sufficiently moist or sticky such that saccharide particulates will adhere when applied to the surface of the material.

As used herein, the terms “plating” or “plated” refer to applying a liquid sensate onto a particulate, such as by spraying, blending or atomizing the liquid sensate, while mixing the particulate and the applied liquid sensate. A liquid sensate that is “plated” onto a particulate may be sorbed into and/or onto, or otherwise adhered to the particulate. Desirably, the sensate is sufficiently absorbed into the particulate, which in some embodiments is a saccharide particulate.

As used herein, the term “associated with” refers to combining the liquid sensate and the particulate so that at least a portion of the liquid sensate is in contact with at least a portion of the particulate. The liquid sensate may be associated with the inner or outer surface of the particulate.

As used herein, the terms “surround,” “surrounding,” and the like are not limited to encircling. These terms may refer to enclosing or confining on all sides, encircling or enveloping, and are not limited to symmetrical or identical thicknesses for a region in a center-fill gum or confectionery product.

The transitional term “comprising,” (also “comprises,” etc.) which is synonymous with “including,” “containing,” or “characterized by,” is inclusive or open-ended and does not exclude additional, unrecited elements or method steps, regardless of its use in the preamble or the body of a claim.

### Sensate-Plated Sanding Composition

In some embodiments a sensate-plated sanding composition is provided. The sensate-plated sanding composition preferably includes a saccharide particulate and at least one sensate plated onto the particulate. In some embodiments, the sensate-plated sanding composition is formed by adding a liquid sensate composition to a particulate blend. In some embodiments, the particulate blend includes ingredients selected from the group consisting of saccharides, food acids, flavors, and combinations thereof. The sensate-plated sanding composition may be applied to a surface of a confectionery or chewing gum composition.

### Saccharide Particulates:

The saccharide particulate may be selected from any saccharide known in the art. For example, the saccharide particulate may be selected from any polyol, sugar, polysaccharide, or combination thereof in particulate form. Suitable saccharide particulates generally include mono-saccharides, di-saccharides and poly-saccharides such as but not limited to, sucrose (sugar), dextrose, maltose, dextrin, xylose, ribose, glucose, mannose, galactose, fructose (levulose), invert sugar, corn syrup solids, maltodextrins, fructo oligo saccharides, partially hydrolyzed starches, corn syrup solids, sorbitol, xylitol, mannitol, galactitol, maltitol, hydrogenated isomaltulose (ISOMALT), lactitol, erythritol, hydrogenated starch hydrolysates, maltitol syrup solids, and mixtures thereof.

In some embodiments, a cooling sensation may be provided by saccharide particulates exhibiting a negative heat of solution including, but not limited to, dextrose and polyols such as xylitol, erythritol, lactitol, mannitol, and sorbitol, and combinations thereof.

The saccharide particulate may be used in any desired amount to provide a 100% total weight in combination with the liquid sensate composition. In some embodiments, the particulate may be present in an amount up to about 99.99% by weight (about 99.99% or less) of the sensate-plated sanding composition. In some embodiments, the particulate may be present in an amount greater than or equal to about 15% by weight of the sensate-plated sanding composition. Specifically, the particulate may be used in an amount from about 20 to about 95% by weight of the sensate-plated sanding composition. In some embodiments, the particulate may be present in the amount of about 50% to about 80% by weight of the sensate-plated sanding composition. In some embodiments, the particulate may be present in an amount of about 55% to about 75% by weight of the sensate-plated sanding composition. Desirably, the particulate may be present in the amount of less than 65% by weight of the sensate-plated sanding composition. Additionally, the sugar/polyol component may be provided in a variety of particle sizes and/or particle size distributions to create a desired texture. For example, particle sizes of from 35 microns to about 150 microns may be used. In some embodiments, the saccharide particulate size distribution where about 95% of the saccharide particulate has an average particle size of less than about 250 microns may be incorporated. In other embodiments, about 60% of the saccharide particulate has an average particle size of less than 250 microns. Desirably, the particle sizes of greater or equal to about 20 microns and less than or equal to about 700 microns may be employed.

### Liquid Sensate Composition:

In some embodiments, the liquid sensate composition may include cooling agents, warming agents, tingling agents, or combinations thereof. In some embodiments of the sensate-plated sanding composition, the liquid sensate composition includes a cooling composition. In other embodiments, the sensate flavor composition may include a warming composition. In some embodiments, the liquid sensate composition may include a tingling composition.

In some embodiments, the liquid sensate composition may further include flavors as discussed in detail below. The liquid sensate composition may be present in the sensate-plated sanding composition in any desired amount; specifically the liquid sensate composition may be present in amount greater than or equal to 0.01% by weight of the sensate-plated sanding composition. In some embodiments, the liquid sensate composition may be present in less than 20.0% of the sensate-plated sanding composition. In other embodiments, the liquid sensate is present in amounts from about 0.01% to about 15.0% by weight of the sensate-plated sanding composition, more specifically from about 0.01% to about 10.0% by weight of the sensate-plated sanding composition, even more specifically, in amounts greater than or equal to 0.05% and less than or equal to 7.50% by weight of the sensate-plated sanding composition. In some embodiments, the liquid sensate composition is present in amounts greater than or equal to 0.1 to less than or equal to 4.0% by weight of the sensate-plated sanding composition. In some embodiments, the liquid sensate composition may be present in the sanding composition in amounts of about 0.15 to about 1.0%. Desirably, the liquid sensate component is present in the amount of about 0.25 to about 0.75% by weight of the sanding composition.

The liquid sensate component may be selected from any sensate known in the art. For example, the liquid sensate may be selected from sensate compositions including cooling agents, warming agents, tingling agents, and combinations thereof. A variety of well known cooling agents may be employed. For example, useful cooling agents may include menthane, menthone, ketals, menthone ketals, menthone glycerol ketals, substituted p-menthanes, acyclic carboxamides, mono menthyl glutarate, substituted cyclohexanamides, substituted cyclohexane carboxamides, substituted ureas and sulfonamides, substituted menthanols, hydroxymethyl and hydroxymethyl derivatives of p-menthane, 2-mercapto-cyclo-decanone, hydroxycarboxylic acids with 2-6 carbon atoms, cyclohexanamides, menthyl acetate, menthyl salicylate, N,2,3-trimethyl-2-isopropyl butanamide (WS-23), N-ethyl-p-menthane-3-carboxamide (WS-3), isopulegol, 3-(1-menthoxy)propane-1,2-diol, 3-(1-menthoxy)-2-methylpropane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, Japanese mint oil, peppermint oil, 341-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol (from Hisamitsu Pharmaceuticals, hereinafter “isopregol”); menthone glycerol ketals (FEMA 3807, tradename FRESCOLAT® type MGA); 3-1-menthoxypropane-1,2-diol (from Takasago, FEMA 3784); and menthyl lactate; (from Haarman & Reimer, FEMA 3748, tradename FRESCOLAT® type ML), WS-30, WS-5, WS-14, Eucalyptus extract (p-Mehtha-3,8-Diol), Menthol (its natural or synthetic derivatives), Menthol PG carbonate, Menthol EG carbonate, Menthol glyceryl ether, N-tertbutyl-p-menthane-3-carboxamide, P-menthane-3-carboxylic acid glycerol ester, Methyl-2-isopryl-bicyclo (2.2.1), Heptane-2-carboxamide; and Menthol methyl ether, and menthyl pyrrolidone carboxylate among others. These and other suitable cooling agents are further described in the following U.S. patents, all of which are incorporated in their entirety by reference hereto: U.S. Pat. Nos. 4,230,688; 4,032,661; 4,459,425; 4,136,163; 5,266,592; 6,627,233.

In some embodiments, suitable cooling agents include menthane, menthone, ketals, menthone ketals, menthone glycerol ketals, substituted p-menthanes, acyclic carboxamides, cyclic carboxamides, mono menthyl glutarate, mono menthyl succinate, substituted cyclohexanamides, substituted cyclohexane carboxamides, substituted ureas and sulfonamides, substituted menthanols, hydroxymethyl and hydroxymethyl derivatives of p-menthane, 2-mercapto-cyclo-decanone, hydroxycarboxylic acids with 2-6 carbon atoms, cyclohexanamides, menthyl acetate, menthyl salicylate, N,2,3-trimethyl-2-isopropyl butanamide, N-ethyl-p-menthane-3-carboxamide, isopulegol, 3-(1-menthoxy)propane-1,2-diol, 3-(1-menthoxy)-2-methylpropane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, Japanese mint oil, peppermint oil, 3-(1-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol, N-(4-cyanomethylphenyl)-p-menthanecarboxamide, menthone glycerol ketals; 3-1-menthoxypropane-1,2-diol and menthyl lactate and combinations thereof.

In some embodiments, warming agents may be selected from a wide variety of compounds known to provide the sensory signal of warming to the user. These compounds offer the perceived sensation of warmth, particularly in the oral cavity, and often enhance the perception of flavors, sweeteners and other organoleptic components. In some embodiments, useful warming compounds may include vanillyl alcohol n-butylether (TK-1000) supplied by Takasago Perfumary Company Limited, Tokyo, Japan, vanillyl alcohol n-propylether, vanillyl alcohol isopropylether, vanillyl alcohol isobutylether, vanillyl alcohol n-aminoether, vanillyl alcohol isoamyleather, vanillyl alcohol n-hexyleather, vanillyl alcohol methylether, vanillyl alcohol ethylether, gingerol, shogaol, paradol, zingerone, capsaicin, dihydrocapsaicin, nordihydrocapsaicin, homocapsaicin, homodihydrocapsaicin, ethanol, isopropyl alcohol, iso-amylalcohol, benzyl alcohol, glycerine, and combinations thereof.

In some embodiments, a tingling sensation may be provided. One such tingling sensation is provided by adding transpellitorin, jambu oleoresin, or spilanthol to some examples. In some embodiments, alkylamides extracted from materials such as jambu or sanshool may be included. Examples of “tingling” type sensates may be found in U.S. Pat. No. 6,780,443, the entire contents of which are incorporated herein by reference for all purposes.

Sensate components may also be referred to as “trigeminal stimulants” such as those disclosed in U.S. Patent Application No. 2005/0202118, which is incorporated herein by reference. Trigeminal stimulants are defined as an orally consumed product or agent that stimulates the trigeminal nerve. Examples of cooling agents which are trigeminal stimulants include menthol, WS-3, N-substituted p-menthane carboxamide, acyclic carboxamides including WS-23, WS-5, WS-14, methyl succinate, and menthone glycerol ketals. Trigeminal stimulants may also include flavors, tingling agents, Jambu extract, vanillyl alkyl ethers, such as vanillyl n-butyl ether, spilanthol, Echinacea extract, Northern Prickly Ash extract, capsaicin, capsicum oleoresin, red pepper oleoresin, black pepper oleoresin, piperine, ginger oleoresin, gingerol, shoagol, cinnamon oleoresin, cassia oleoresin, cinnamic aldehyde, eugenol, cyclic acetal of vanillin and menthol glycerin ether, unsaturated amides, and combinations thereof. Other cooling compounds may include derivatives of 2,3-dimethyl-2-isopropylbutyric acid such as those disclosed in U.S. Pat. No. 7,030,273, which is incorporated herein by reference.

In some embodiments, sensate components are used at levels that provide a perceptible sensory experience i.e. at or above their threshold levels. In other embodiments, sensate components are used at levels below their threshold levels such that they do not provide an independent perceptible sensory experience. At subthreshold levels, the sensates may provide an ancillary benefit such as flavor or sweetness enhancement or potentiation.

### Additional Ingredients for the Sensate-Plated Sanding Composition:

In some embodiments, the sensate-plated sanding composition may further include additional ingredients. These additional ingredients may be added to the liquid sensate prior to plating on the saccharide particulate, added to the saccharide particulate prior to being plated with the liquid sensate, added to the sensate-plated sanding composition after plating has occurred, or any combination thereof.

In some embodiments, the sensate-plated sanding composition may further include a sorption aid. The sorption aid may increase the capacity of the particulate component to absorb and/or adsorb more liquid sensate. The sorption aid may be selected from maltodextrins, silicates, celluloses, starches, gum arabics, silicas, zeolites, and combinations thereof. In some embodiments, the type of particulate and sorption aid may alter the amount of sensate that may be plated onto the particulate.

For example, in some embodiments, the sensate-plated sanding composition may include a sorption aid such as silicon dioxide. In this embodiment, the liquid sensate may be present in an amount equal to or less than about 20.0% by weight of the sensate-plated sanding composition. In some embodiments, the liquid sensate may be present in an amount equal to or greater than 0.01% by weight of the sensate-plated sanding composition. In some embodiments, the liquid sensate may be present in an amount equal to or greater than 0.01% to less than 20.0% by weight of the sensate-plated sanding composition. In other embodiments, the liquid sensate may be present in an amount of about 5.0% to about 18.0% by weight of the sensate-plated sanding composition. In some embodiments, the liquid sensate may be present in an amount of about 10.0% to about 15.0% by weight of the sensate-plated sanding composition. In other embodiments, the liquid sensate may be present in an amount equal to or less than about 10% by weight of the sensate-plated sanding composition.

In other embodiments, the sensate-plated sanding composition may include a sorption aid such as maltodextrins. In this embodiment, the liquid sensate may be present in an amount equal to or less than about 10.0%. In other embodiments, the liquid sensate may be present in an amount of about 0.01% to about 10.0%. In some embodiments, the liquid sensate may be present in an amount equal to or greater than 1.0% to an amount equal to or less than about 8% by weight of the sanding composition. In some embodiments, the liquid sensate may be present in an amount equal to or less than 4.0% by weight of the sensate-plated sanding composition.

In some embodiments, the sensate-plated sanding composition may include a sorption aid including a blend of particulates, such as silicas and maltodextrins. In this embodiment, the sensate-plated sanding composition may include liquid sensate in the amount equal to or less than 15% by weight of the sensate-plated sanding composition. In some embodiments, the liquid sensate is present in an amount equal to or greater than 0.1% to less than 10.0% by weight of the sensate-plated sanding composition. In other embodiments, the liquid sensate may be present in an amount of about 4% to about 10% by weight of the sensate-plated sanding composition. In other embodiments, the liquid sensate is present in an amount of about 5.0% to about 7.0% by weight of the sensate-plated sanding composition.

In embodiments the sensate-plated sanding composition may further comprise additional ingredients selected from food acids, flavors, sensates, sweeteners, salts, functional ingredients and combinations thereof. Each of the ingredients may be present in an amount equal to or greater than about 0.01% by weight of the sensate-plated sanding composition. In some embodiments, the ingredients may be present in an amount equal to or less than about 20% by weight of the sensate-plated sanding composition. In some embodiments, the ingredients are present in an amount from about 0.01% by weight to about 20% by weight of the sensate-plated sanding composition, preferably from about 5% by weight of the sensate-plated sanding composition to about 15% by weight of the sensate-plated sanding composition of the sensate-plated sanding composition.

In one embodiment, the liquid sensate composition may be plated on the particulate by powder blending techniques such as spraying and tumbling. Other techniques of plating the liquid sensate composition onto the particulate may be used.

In another embodiment the saccharide particulate may be coated with a liquid sensate composition by blending the particulate with the liquid sensate composition. The liquid sensate composition is added to a mixing bowl, container or mixer. The particulates are added to the liquid sensate composition and the combination is vigorously mixed. The amount the liquid sensate composition that the particulate can absorb, adsorb or associate with while maintaining its flowability depends on the nature of the liquid and the particulate. Thus, the maximum amount of sensate that can be added to the particulate is dependent on the sensate itself and the particulate to which it will be associated. The powder blending of the components may occur at ambient temperatures. The blending is complete when the liquid sensate is completely sorbed onto/into the particulates.

### Sweeteners:

The sensate-plated sanding composition may further include a sweetener in addition to the saccharide particulate component. The additional sweeteners may be included in saccharide particulate, e.g. a blend of sweeteners to form a particulate, and/or the additional sweeteners may be included in the liquid sensate composition prior to plating. Sweeteners may include sugar bulk sweeteners, sugarless bulk sweeteners, or the like, high intensity sweeteners, or mixtures thereof. Suitable sugar bulk sweeteners generally include mono-saccharides, di-saccharides and poly-saccharides such as but not limited to, sucrose (sugar), dextrose, maltose, dextrin, xylose, ribose, glucose, mannose, galactose, fructose (levulose), invert sugar, corn syrups, maltodextrins, fructo oligo saccharide syrups, partially hydrolyzed starch, corn syrup solids and mixtures thereof.

Suitable sugarless bulk sweeteners include sugar alcohols (or polyols) such as, but not limited to, sorbitol, xylitol, mannitol, galactitol, maltitol, hydrogenated isomaltulose (ISOMALT), lactitol, erythritol, hydrogenated starch hydrolysates, maltitol syrups, polyglycitol syrups, and mixtures thereof.

Suitable hydrogenated starch hydrolysates include those disclosed in U.S. Pat. No. 4,279,931 and various hydrogenated glucose syrups and/or powders which contain sorbitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydro lysates different properties. Mixtures of hydrogenated starch hydrolysates, such as LYCASIN®, a commercially available product manufactured by Roquette Freres of France, and HYSTAR®, a commercially available product manufactured by SPI Polyols, Inc. of New Castle, Del., are also useful.

In some embodiments, high-intensity sweeteners also may be included as sweetening agents in the saccharide particulate and/or in the liquid sensate composition. Without being limited to particular high-intensity sweeteners, representative categories and examples include:

(a) water-soluble sweetening agents such as dihydrochalcones, monellin, stevia, steviosides, rebaudioside A, glycyrrhizin, dihydroflavenol, and sugar alcohols such as sorbitol, mannitol, maltitol, xylitol, erythritol and L-aminodicarboxylic acid aminoalkenoic acid ester amides, such as those disclosed in U.S. Pat. No. 4,619,834, which disclosure is incorporated herein by reference, and mixtures thereof;

(b) water-soluble artificial sweeteners such as soluble saccharin salts, i.e., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and mixtures thereof;

(c) dipeptide based sweeteners, such as L-aspartic acid derived sweeteners, such as L-aspartyl-L-phenylalanine methyl ester (Aspartame) and materials described in U.S. Pat. No. 3,492,131, L-alphaaspartyl-N-(2,2,4,4-tetramethyl-3-thietanyl)-D-alaninamide hydrate (Alitame), N-[N-(3,3-dimethylbutyl)-L-aspartyl]-L-phenylalanine 1-methyl ester (Neotame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, and mixtures thereof;

(d) salts (also referred to as molecular or ionic combinations) of aspartame and acesulfame including the sweetener known by the trade name TWINSWEETT™.

(e) water-soluble sweeteners derived from naturally occurring water-soluble sweeteners, such as chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-furanoside, or 4,1′-dichloro-4,1′-dideoxygalactosucrose; 1′,6′-dichloro 1′,6′-dideoxysucrose; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′,6′-tetrachloro-4,6,1′,6′-tetradeoxygalacto-sucrose; and 4,6,1′,6′-tetradeoxy-sucrose, and mixtures thereof;

(f) protein based sweeteners such as thaumatococcus danielli (Thaumatin I and II) and talin;

(g) the sweetener monatin (2-hydroxy-2-(indol-3-ylmethyl)-4-aminoglutaric acid) and its derivatives; and

(g) the sweetener Lo han guo (sometimes also referred to as “Lo han kuo” or “Lo han quo”).

The intense sweetening agents may be used in many distinct physical forms well-known in the art to provide an initial burst of sweetness and/or a prolonged sensation of sweetness. Without being limited thereto, such physical forms include free forms, spray dried forms, powdered forms, beaded forms, encapsulated forms, and mixtures thereof. In one embodiment, the sweetener is a high intensity sweetener such as aspartame, sucralose, and acesulfame potassium (e.g., Ace-K).

In general, an effective amount of intense sweetener may be utilized to provide the level of sweetness desired, and this amount may vary with the sweetener selected. The intense sweetener may be present in amounts from about 0.001% to about 3%, by weight of the total composition, depending upon the sweetener or combination of sweeteners used. The exact range of amounts for each type of sweetener may be selected by those skilled in the art.

In some embodiments wherein a high intensity sweetener is included, the sweetener may be sucralose, saccharin salts, acesulfame potassium, aspartame, aspartame-acesulfame salt, thaumatin, monatin (2-hydroxy-2-(indol-3-ylmethyl)-4-amino glutaric acid), neotame, alitame, and combinations thereof.

### Flavor Ingredients (Including Flavor Potentiators Ingredients):

In some embodiments, the sensate-plated sanding composition may further include flavors. The flavors may include those flavors known to the skilled artisan, such as natural and artificial flavors. These flavors may be chosen from synthetic flavor oils and flavoring aromatics and/or oils, oleoresins and extracts derived from plants, leaves, flowers, fruits, and so forth, and combinations thereof. Nonlimiting representative flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Also useful flavorings are artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, pineapple, apricot, banana, melon, apricot, ume, cherry, raspberry, blackberry, tropical fruit, mango, mangosteen, pomegranate, papaya and so forth. Other potential flavors whose release profiles may be managed include a milk flavor, a butter flavor, a cheese flavor, a cream flavor, and a yoghurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a camomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. These flavoring agents may be used in liquid or solid form and may be used individually or in admixture. Commonly used flavors include mints such as peppermint, menthol, spearmint, artificial vanilla, cinnamon derivatives, and various fruit flavors, whether employed individually or in admixture. Flavors may also provide breath freshening properties, particularly the mint flavors when used in combination with the cooling agents, described herein below.

In some embodiments, other flavors including aldehydes and esters such as cinnamyl acetate, cinnamaldehyde, citral diethylacetal, dihydrocarvyl acetate, eugenyl formate, p-methylamisol, and so forth may be used. Generally any flavor or food additive such as those described in Chemicals Used in Food Processing, publication 1274, pages 63-258, by the National Academy of Sciences, may be used. This publication is incorporated herein by reference. These may include natural as well as synthetic flavors.

Further examples of aldehyde flavorings include but are not limited to acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, .e., melonal (melon), 2,6-dimethyloctanal (green fruit), and 2-dodecenal (citrus, mandarin), cherry, grape, blueberry, blackberry, strawberry shortcake, and mixtures thereof.

Potentiators may consist of materials that may intensify, supplement, modify or enhance the taste and/or aroma perception of an original material without introducing a characteristic taste and/or aroma perception of their own. In some embodiments, potentiators designed to intensify, supplement, modify, or enhance the perception of flavor, sweetness, tartness, umami, kokumi, saltiness and combinations thereof may be included.

In some embodiments, examples of suitable potentiators, also known as taste potentiators include, but are not limited to, neohesperidin dihydrochalcone, chlorogenic acid, alapyridaine, cynarin, miraculin, glupyridaine, pyridinium-betain compounds, glutamates, such as monosodium glutamate and monopotassium glutamate, neotame, thaumatin, tagatose, trehalose, salts, such as sodium chloride, monoammonium glycyrrhizinate, vanilla extract (in ethyl alcohol), sugar acids, potassium chloride, sodium acid sulfate, hydrolyzed vegetable proteins, hydrolyzed animal proteins, yeast extracts, adenosine monophosphate (AMP), glutathione, nucleotides, such as inosine monophosphate, disodium inosinate, xanthosine monophosphate, guanylate monophosphate, alapyridaine (N-(1-carboxyethyl)-6-(hydroxymethyl)pyridinium-3-ol inner salt, compositions comprising 5′-nucleotides such as those disclosed in US 2006/0078972 to Noordam et al, which is incorporated in its entirety herein by reference, sugar beet extract (alcoholic extract), sugarcane leaf essence (alcoholic extract), curculin, strogin, mabinlin, gymnemic acid, hydroxybenzoic acids, 3-hydrobenzoic acid, 2,4-dihydrobenzoic acid, citrus aurantium, vanilla oleoresin, sugarcane leaf essence, maltol, ethyl maltol, vanillin, licorice glycyrrhizinates, compounds that respond to G-protein coupled receptors (T2Rs and T1Rs) and taste potentiator compositions that impart kokumi, as disclosed in U.S. Pat. No. 5,679,397 to Kuroda et al., which is incorporated in its entirety herein by reference. “Kokumi” refers to materials that impart “mouthfulness” and “good body”.

Sweetener potentiators, which are a type of taste potentiator, enhance the taste of sweetness. In some embodiments, exemplary sweetener potentiators include, but are not limited to, monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, sugar beet extract, neotame, thaumatin, neohesperidin dihydrochalcone, hydroxybenzoic acids, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs) and combinations thereof.

Additional examples of potentiators for the enhancement of salt taste include acidic peptides, such as those disclosed in U.S. Pat. No. 6,974,597, herein incorporated by reference. Acidic peptides include peptides having a larger number of acidic amino acids, such as aspartic acid and glutamic acid, than basic amino acids, such as lysine, arginine and histidine. The acidic peptides are obtained by peptide synthesis or by subjecting proteins to hydrolysis using endopeptidase, and if necessary, to deamidation. Suitable proteins for use in the production of the acidic peptides or the peptides obtained by subjecting a protein to hydrolysis and deamidation include plant proteins, (e.g. wheat gluten, corn protein (e.g., zein and gluten meal), soybean protein isolate), animal proteins (e.g., milk proteins such as milk casein and milk whey protein, muscle proteins such as meat protein and fish meat protein, egg white protein and collagen), and microbial proteins (e.g., microbial cell protein and polypeptides produced by microorganisms).

In some embodiments, flavors and/or potentiators are used at levels that provide a perceptible sensory experience, i.e. at or above their threshold levels. In other embodiments, flavors and/or potentiators are used at levels below their threshold levels such that they do not provide an independent perceptible sensory experience. At subthreshold levels, the flavors and/or potentiators may provide an ancillary benefit such as flavor enhancement or potentiation.

In some embodiments, the flavors and/or potentiators may be used in many distinct physical forms. In some embodiments, a flavor and/or potentiators may be employed in either liquid form and/or dried form. When employed in the latter form, suitable drying means such as spray drying the liquid may be used. Alternatively, the flavor and/or potentiators may be absorbed onto water soluble materials, such as cellulose, starch, sugar, maltodextrin, gum arabic and so forth, or combinations thereof, or the flavor may be encapsulated. In still other embodiments, the flavor and/or potentiator may be adsorbed onto silicas, zeolites, and the like. In some embodiments, flavors and/or potentiators can be employed in free or unencapsulated form, in beaded form, in encapsulated form, or in combinations thereof.

In some embodiments, the sensate-plated sanding composition may further include a flavor. In some embodiments, the liquid sensate is combined with the flavor and the combination is then plated onto the particulate. In such cases, the weight ratios of liquid sensate to flavor may be from 0.1:10 to 10:0.1.

### Functional Ingredients:

Functional ingredients may also be included in the sensate-plated sanding compositions and these include, but are not limited to, medicaments, nutrients such as vitamins and minerals and the like, nutraceuticals such as phytochemicals and the like, breath freshening agents, oral care agents, probiotic materials, prebiotic materials, and throat care agents.

### Food Acids:

In some embodiments, the sensate-plated sanding composition further includes food acids. Food acids may be selected such that they provide a sour taste intensity of at least 4 on a scale from 0 to 10. Scales that may be used to measure sour taste have been developed by several sensory researchers. One example of a scale has been developed by Dr. Howard Moskowitz and is discussed in the journal article entitled Sourness of Acid Mixtures as published in The Journal of Experimental Psychology, April 1974; 102(4); 640-7 and in the journal article entitled Ration Scales of Acid Sourness as published in Perception and Psychophysics; 9:371-374, 1971.

Where a sensate-plated sanding composition with a sour taste perception is desired, the sensate-plated sanding composition may include food acids. In some embodiments, the food acid is a food acid particulate. In other embodiments, the food acid is an acid blend including food acids selected from the group consisting of citric acid, malic acid, lactic acid, tartaric acid, ascorbic acid, and combinations thereof. It has been found that including food acids with hygroscopicities lower than citric acid in the sensate-plated sanding composition will reduce the amount of water being pulled from the confectionery base and thus improve the keeping quality of the sensate-plated sanded confection. In some embodiments, the acid is selected from acetic acid, adipic acid, ascorbic acid, butyric acid, citric acid, formic acid, fumaric acid, glyconic acid, lactic acid, phosphoric acid, malic acid, oxalic acid, succinic acid, tartaric acid, citrates, and combinations thereof. Food acids with hygroscopicities lower than citric acid may be selected from malic acid, lactic acid, tartaric acid, ascorbic acid and combinations thereof. Also, food acids with hygroscopicities lower than the hygroscopicity of the gummy candy shell may reduce moisture migration.

In some embodiments, a sensate-plated sanding composition with a sour taste perception similar to the sour taste perception provided by citric acid is desired. The sour taste perception of an aqueous solution of 0.2% w/w of citric acid has been characterized as providing clean and refreshing tartness. In some embodiments, a coating with a sour taste perception similar to the sour taste perception of a 0.2% w/w solution of citric acid is created by using acids other than citric acid. In still other embodiments, a sensate-plated sanding composition with a sour taste perception similar to the sour taste perception of a 0.2% w/w solution of citric acid is created with one or more food acids with hygroscopicities lower than citric acid.

In some embodiments, a sensate-plated sanding composition with a sour taste intensity of at least 4 on a scale of 0 to 10 is desired. In still other embodiments, a sensate-plated sanding composition with a sour taste intensity of at least 4 on a scale of 0 to 10 is created using one or more food acids with hygroscopicities less than citric acid.

In other embodiments, the amount of acid used is determined by calculating the number of hydrogen ions released by a given acid or acid blend relative to the number of hydrogen ions released by a particular amount of citric acid. Adjustments may then be made in the amount of the acid(s) to provide the same number of released hydrogen ions that would be released by that particular amount of citric acid.

### Color Ingredients:

In some embodiments, one or more colors can be included. As classified by the United States Food, Drug, and Cosmetic Act (21 C.F.R. 73), colors can include exempt from certification colors (sometimes referred to as natural even though they can be synthetically manufactured) and certified colors (sometimes referred to as artificial), or combinations thereof. In some embodiments, exempt from certification or natural colors can include, but are not limited to annatto extract, (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rhodoxanthin (E161f), caramel (E150(a-d)), β-apo-8′-carotenal (E160e), β-carotene (E160a), alpha carotene, gamma carotene, ethyl ester of beta-apo-8 carotenal (E160f), flavoxanthin (E161a), lutein (E161b), cochineal extract (E120); carmine (E132), indigo carmine, carmoisine/azorubine (E122), sodium copper chlorophyllin (E141), chlorophyll (E140), chlorophyllin, copper chlorophyllin, copper chlorophyll, curcumin/copper chlorophyllin, toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot, carrot oil, corn endosperm oil, paprika, paprika oleoresin, paprika extract, phaffia yeast, riboflavin (E101), saffron, turmeric (E100), turmeric oleoresin, tumeric root, amaranth (E123), capsanthin/capsorbin (E160c), lycopene (E160d), black carrot, black carrot extract, elderberry, aronia, allura red, curcumin, spinach, stinging nettle, burnt sugar, carbo medicinalis, and combinations thereof.

In some embodiments, certified colors can include, but are not limited to, FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), brilliant blue FCF, titanium dioxide (E171), aluminium (E173), allura red, silver (E174), gold (E175), pigment rubine/lithol rubine BK (E180), calcium carbonate (E170), carbon black (E153), black PN/brilliant black BN (E151), brown HT, green S, green S/acid brilliant green BS (E142), and combinations thereof. In some embodiments, certified colors can include FD&C aluminum lakes. These consist of the aluminum salts of FD&C dyes extended on an insoluble substrate of alumina hydrate. Additionally, in some embodiments, certified colors can be included as calcium salts.

### Multi-Region Sensate-Plated Sanded Confectionery Compositions

In some embodiments, the sensate-plated sanding composition is applied to a confectionery base composition to form a multi-region sensate-plated sanded confectionery composition. In these embodiments, the sensate-plated sanding composition forms a second region that may be present in an amount equal to or greater than 0.5% by weight of the sensate-plated sanded confectionery composition. In some embodiments, the sensate-plated sanding composition is present in an amount equal to or of less than about 25% by weight of the sensate-plated sanded confectionery composition. In some embodiments, the sensate-plated sanding composition is present in an amount of about 3% to about 20% by weight of the sensate-plated sanded confectionery composition. In some embodiments, the sensate-plated sanding composition is present in an amount of about 5% to about 18% by weight of the sensate-plated sanded confectionery composition. In some embodiments, a ratio of confectionery base to sensate-plate sanding composition is between 4:1 to 50:1. Desirably, the sensate-plated sanding composition is present in an amount of about 7% to about 15% by weight of the total sensate-plated sanded confectionery composition.

The sensate-plated sanding compositions may be used in combination with a variety of confectionery base compositions including confectionary or chewing gum products to form the sensate-plated sanded confectionery composition. In some embodiments, the confectionary base composition can form a first region and may include, but are not limited to, starch-based jelly candy, gelatin based jelly candy (also known as gummy or gummi candy), pectin based jelly candy (also known as jelly candy), carageenan based jelly candy, hard candies, lozenges, as well as other chewy candies such as marshmallows, taffies, caramels and licorice. Also included in those chewable candy forms are soft candies such as, but not limited to, gum drops, licorice, fruit snacks, starch based jellies, gelatin based jellies, pectin based jellies, carageenan based jellies, agar based jellies, konjac based jellies, chewy candy, starch candy, nougat, toffee, taffy, marshmallow, fondant, fudge, chocolate, compound coating, carob coating, caramel, compressed tablets, candy floss (also known as cotton candy), marzipan, hard boiled candy, nut brittles, pastilles, pralines, nonpareils, dragees, lozenges, sugared nuts, comfits, aniseed balls, nougatine, and jelly beans. The base of the confectionery may be a sugar/glucose syrup combination or a polyol/polyol syrup combination and a gelatinizing agent, the latter of which may be gelatin, agar, gum arabic, maltodextrin, pectin, modified starches or combinations thereof. Various other gums (also referred to as hydrocolloids) may also be used. The gelatinizing material may be desirably dissolved in water or otherwise hydrated prior to mixing with the sugar/glucose syrup combination. If a hydrocolloid such as pectin is used as the gelatinizing agent, then the pectin is desirably dry mixed with a portion of the sugar or bulk sweetener prior to addition of the dry mixture to water.

In some embodiments, the confectionery base composition is selected from the group consisting of chewy candy, gummy candy, marshmallow, chewing gum, and combinations thereof.

Bulk sweeteners generally are present in amounts of about 5% to about 99% by weight of the confectionery base composition.

In some embodiments, the confectionery base compositions may include multi-region confections such as center-filled or layered confections. The chewing gum compositions may include any form of chewing gum, such as, slab, pellet, sticks, center-fill gums, bubble gums, candy gums, multi-region gums, and multi-layer gums.

In some embodiments, the application of the sensate-plated sanding composition to the exterior of a confectionery base candy piece may be accomplished by using moisture such as by steam treating the exterior of the candy piece and then applying the sensate-plated sanding composition in a tumbling operation. In some embodiments, the application of a sensate-plated sanding composition to the exterior of a candy piece may be accomplished by wetting the surface of the candy piece through the application of a liquid prior to application of the sensate-plated sanding composition. The liquid used to wet the surface of the candy piece may be aqueous, non-aqueous, or a combination thereof.

In embodiments where steam is applied to the surface of the confectionery base composition, the process is otherwise kept under ambient conditions. Thus, the sensate-plated sanding compositions may be subject to temperatures as high as that of the steam. It is surprising and unexpected that the liquid sensate is able to survive the high temperature of the steam and still provide desired sensation to the consumer. In some embodiments, the confectionery base composition surface temperature is considerably lower than that of the steam. In some embodiments, the sensate-plated sanding composition may be embedded into the surface of the confection. In other embodiments, the particulate adheres to the confection without being embedded.

In some embodiments, a wetting syrup may also be applied to the surface of the product. The wetting syrup may be aqueous, non-aqueous, or combinations thereof. An aqueous wetting syrup may be used with any of the confectionery base compositions and particulate coatings described herein which are moisture tolerant. For instance, aqueous wetting syrups may include dextrin, saccharides and water, in some embodiments. Other embodiments may include water-based shellacs, saccharides, hydrocolloids and water. A non-aqueous wetting syrup may be used with any of the confectionery compositions and sanding compositions described in detail above which are not moisture tolerant. For instance, non-aqueous wetting syrups may include 0-25% water, resins, fats, waxes, liquid oils and combinations thereof. In addition, the non-aqueous wetting syrup may include a solvent based shellac.

In some embodiments, the wetting syrup can include any of the flavor ingredients described above. In some embodiments, the wetting syrup can include a color ingredient as described above.

In some embodiments, the tackiness of a confectionery surface to which an aqueous wetting syrup has been applied may be manipulated by varying the drying conditions. Manipulating the tackiness of a confectionery surface affects the adherence of various particle size distributions of the particulate coating being adhered to the surface of the confectionery composition. In some embodiments, longer drying times increase the tackiness of the confectionery surface. When the confectionery surface is tackier, larger particles will adhere. In some embodiments, drying time of 30 to 60 seconds results in adherence of particles with particle sizes of greater than 100 microns.

In some embodiments, shorter drying times increase the wetness of the confectionery surface. When the confectionery surface is wetter, smaller particles will adhere. In some embodiments, drying time of 0-30 seconds results in adherence of particles with particle sizes of 5-100 microns.

In some embodiments, a sensate-plated sanding composition may include a range of particle sizes. For example, a sensate-plated sanding composition including 33% of particles from 10-60 microns plus 33% of particles from 60-110 microns plus 33% of particles from 110 microns and above could be adhered to a confectionery surface by drying for 45-60 seconds following application of an aqueous wetting syrup.

In some embodiments, the tackiness of a confectionery surface to which a non-aqueous wetting syrup has been applied can be manipulated by varying the concentration of the non-aqueous components in the wetting syrup. In some embodiments, a more concentrated wetting syrup will adhere larger particle sized particles. In some embodiments, a more dilute wetting syrup will adhere smaller particle sized particles.

In some embodiments, moisture sensitive ingredients such as carbonated or gasified candy can be included in the particulate coating composition.

In other embodiments, the coating is applied using conventional soft or hard panning processes. These processes can include the sequential application of multiple layers of wet and dry materials that build up to form the coating. Encapsulated ingredients can be added in either the wet or dry materials or both.

In some embodiments, the sensate-plated sanding composition may adhere to the surface of the confection due to electrostatic adhesion. In some embodiments, application of the sensate-plated sanding composition may be accomplished by physical contact between the surface or surfaces of the confection and the sensate-plated sanding composition without wetting the surface(s) of the confection and with subsequent removal of the excess particulates. In some embodiments, excess particulate coating may be removed from the surface of the confection by applying a vacuum, by brushing, and by other like processes. This process may also be known as dusting.

### Sensate-Plated Sanded Gummy Candy Composition

In some embodiments, a sensate-plated sanded gummy candy composition is provided. The sensate-plated sanded gummy candy confectionery composition may include a sensate-plated sanding composition, as described above, and a confectionery base composition including a gummy candy composition. The gummy candy composition may include any conventional gummy candy material such as, but not limited to, sweeteners, hydrocolloids, and food acids. Suitable examples of these materials are described above and may be used with equal applicability here. For the hydrocolloid materials, in some embodiments, a desired texture is created by using hydrocolloids that form chewable gels when combined with the other ingredients in the gummy candy composition.

In some embodiments, pectin and gelatin may be used together in a gummy candy composition as described in U.S. application Ser. No. 10/977,585, filed Oct. 28, 2004 and incorporated herein for all purposes.

In some embodiments, the gummy candy composition may contain sweeteners in amounts from about 35% w/w to about 75% w/w of the gummy candy composition. In some embodiments, the gummy candy composition may contain from about 0.01% w/w to about 15% w/w, and preferably from about 1% to about 8% w/w of hydrocolloids. In some embodiments, the gummy candy composition may contain from about 0.3% to about 3%, and preferably from about 0.5% w/w and about 2.0% w/w food acids.

In some embodiments, the gummy candy composition can also include buffering agents, coloring, flavoring, and preservatives.

Further, in some embodiments, the gummy candy composition can include any functional ingredients as discussed above.

In some embodiments, the gummy candy composition can include flavors and/or sensates as discussed above.

In some embodiments, the gummy candy composition can be included in a sensate-plated sanded gummy candy composition in amounts from about 70 percent by weight of the total composition to about 95 percent by weight of the total composition.

### Sensate-Plated Sanded Chewing Gum Compositions

In some embodiments, a sensate-plated sanded chewing gum composition is provided. The sensate-plated sanded chewing gum composition may include a sensate-plated sanding composition, as described above, and a confectionery base composition including a chewing gum composition. Chewing gum compositions may be provided in a variety of different forms, such as, for example, slab, pellet, sticks, balls, cubes, center-fill gums, candy gum, multi-region gum, multi-layer gum, bubble gum, deposited gums and compressed gums. The chewing gum compositions also may include at least one flavor and a variety of optional additives.

The chewing gum composition also may include a gum base. The gum base may include any component known in the chewing gum art. Such components may be water soluble, water-insoluble or a combination thereof. For example, the gum base may include elastomers, bulking agents, waxes, elastomer solvents, emulsifiers, plasticizers, fillers and mixtures thereof. Examples of chewing gum compositions useful with the sensate-plated sanding compositions include U.S. Patent Publication Numbers 2006/0051456, 2006/0045934, and 2006/0286202 among others, the subject matter of which is incorporated herein by reference.

The elastomers (rubbers) employed in the chewing gum base will vary greatly depending upon various factors such as the type of chewing gum base desired, the consistency of chewing gum composition desired and the other components used in the composition to make the final chewing gum product. The elastomer may be any water-insoluble polymer known in the art, and includes those chewing gum polymers utilized for chewing gums and bubble gums. Illustrative examples of suitable polymers in chewing gum bases include both natural and synthetic elastomers. For example, those polymers which are suitable in chewing gum base compositions include, without limitation, natural substances (of vegetable origin) such as chicle, natural rubber, crown gum, nispero, rosidinha, jelutong, perillo, niger gutta, tunu, balata, guttapercha, lechi capsi, sorva, gutta kay, and the like, and mixtures thereof. Examples of synthetic elastomers include, without limitation, styrene-butadiene copolymers (SBR), polyisobutylene, isobutylene-isoprene copolymers, polyethylene, polyvinyl acetate and the like, and mixtures thereof.

The chewing gum base may also include plasticizers or softeners to provide a variety of desirable textures and consistency properties. Because of the low molecular weight of these ingredients, the plasticizers and softeners are able to penetrate the fundamental structure of the chewing gum base making it plastic and less viscous. Useful plasticizers and softeners include lanolin, palmitic acid, oleic acid, stearic acid, sodium stearate, potassium stearate, glyceryl triacetate, glyceryl lecithin, glyceryl monostearate, propylene glycol monostearate, acetylated monoglyceride, glycerine, and the like, and mixtures thereof. Waxes, for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, propylene glycol, mixtures thereof, and the like, may also be incorporated into the chewing gum base. The plasticizers and softeners are generally employed in the chewing gum base in amounts up to about 20% by weight of the chewing gum base, and more specifically in amounts from about 9% to about 17%, by weight of the chewing gum base.

A variety of traditional ingredients may be optionally included in the chewing gum base in effective amounts such as flavor agents and coloring agents, antioxidants, preservatives, and the like, some of which are described in more detail above in the section entitled “Additional Ingredients”. For example, titanium dioxide and other dyes suitable for food, drug and cosmetic applications, known as F. D. & C. dyes, may be utilized. An anti-oxidant such as butylated hydroxytoluene (BHT), butylated hydroxyanisole (BHA), propyl gallate, vitamin E and mixtures thereof, may also be included. Other conventional chewing gum additives known to one having ordinary skill in the chewing gum art may also be used in the chewing gum base.

Chewing gum products may be prepared using standard techniques and equipment known to those skilled in the art. The apparatus useful in accordance with the embodiments described herein includes mixing and heating apparatus well known in the chewing gum manufacturing arts, and therefore the selection of the specific apparatus will be apparent to the artisan. For general chewing gum preparation processes see U.S. Pat. Nos. 4,271,197 to Hopkins et al, 4,352,822 to Cherukuri et al and 4,497,832 to Cherukuri et al, each of which is incorporated herein by reference in its entirety.

In some embodiments, the chewing gum confectionery base composition can be included in a sensate-plated sanded chewing gum composition in amounts from about 70 percent by weight of the total composition to about 95 percent by weight of the total composition.

In some embodiments, the application of the sensate-plated sanding composition to the exterior of a chewing gum confectionery base may be accomplished by using moisture such as by steam treating the exterior of the chewing gum composition and then applying the sensate-plated sanding composition in a tumbling operation. In some embodiments, the application of a sensate-plated sanding composition to the exterior of a chewing gum composition may be accomplished by wetting the surface of the chewing gum through the application of a liquid prior to application of the sensate-plated sanding composition. The liquid used to wet the surface of the chewing gum may be aqueous, non-aqueous, or a combination thereof.

### Center-Fill Composition

In some embodiments, there is provided a center-fill or third region, which is included in a confectionery base composition such as a center-fill chewing gum or a center-fill confectionery composition. In these embodiments, the third region is at least partially surrounded by the first region. The center-fill chewing gum composition may include a center-fill composition and a chewing gum region. The center-fill confectionery composition may include a center-fill composition and a confectionery region. The center-fill composition may include any conventional filling or combination of filling materials. The center-fill may be sugar or sugar-free and it may contain fat or be fat-free. Additionally, the center-fill may contain vegetable-based, dairy-based or fruit-based materials such as, but not limited to, fruit juices, fruit concentrates, fruit purees, dried fruit materials, and the like. Further, in some embodiments, the center-fill component may include one or more sweeteners such as those discussed above. The center-fill may also include one or more hydrocolloid materials.

In some embodiments, hydrocolloid materials may include naturally occurring materials such as plant exudates, seed gums, and seaweed extracts or they may be chemically modified materials such as cellulose, starch, or natural gum derivatives. In some embodiments, hydrocolloid materials may include starches, flour, pectin, gum arabic, acacia gum, alginates, agar, carageenans, guar gum, xanthan gum, locust bean gum, gelatin, gellan gum, galactomannans, tragacanth gum, karaya gum, curdlan, konjac, chitosan, xyloglucan, beta glucan, furcellaran, gum ghatti, tamarin, bacterial gums, and combinations thereof. Additionally, in some embodiments, modified natural gums such as propylene glycol alginate, carboxymethyl locust bean gum, low methoxyl pectin, and their combinations may be included. In some embodiments, modified celluloses may be included such as microcrystalline cellulose, carboxymethlcellulose (CMC), methylcellulose (MC), hydroxypropylmethylcellulose (HPCM), and hydroxypropylcellulose (MPC), and combinations thereof. In some embodiments, it is desirable to include hydrocolloid materials that increase the viscosity of the center-fill composition.

In some embodiments, the texture of the center-fill is the same as the texture of the chewing gum or confectionery composition. In other embodiments, the texture of the center-fill is different than the texture of the chewing gum or confectionery composition.

In some embodiments, the appearance of the center-fill is the same as the appearance of the chewing gum or confectionery composition. In other embodiments, the appearance of the center-fill is different than the appearance of the chewing gum or confectionery composition.

The center-fill chewing gum or confectionery composition may also include one or more food acids as discussed above. These food acids or blends thereof may be included in amounts from about 0.5% w/w to about 5.0% w/w of the center-fill composition. In some embodiments, buffering agents such as citrates may be included.

In some embodiments, the center-fill chewing gum or confectionery composition may include buffering agents, coloring, flavoring, and preservatives. Further, in some embodiments, the center-fill composition may include any of the functional ingredients as discussed above. In some embodiments, the center-fill composition may include any of the flavors and/or sensates as discussed above.

In some embodiments, the center-fill composition may be included in the coated center-filled chewing gum or confectionery composition in amounts from about 1 percent by weight of the total composition to about 25 percent by weight of the total composition.

### Intermediate Region Composition

In some embodiments, for example, a sensate-plated sanded confectionery or gum composition may further include a hard or soft intermediate region in between the first and second regions. In such embodiments, an intermediate region composition is first applied over the chewing gum or confectionery base composition, followed by the sensate-plated sanding composition. The intermediate region composition may include any conventional ingredient such as, but not limited to, sweeteners, flavors, sensates, functional ingredients, food acids and combinations thereof. In some embodiments, the intermediate region composition may be in crystalline form, or amorphous form. In some embodiments, the intermediate region composition may be continuous or discontinuous. In some embodiments, the intermediate region may completely surround, coat, cover, or enclose a chewing gum or confectionery base. In other embodiments, the intermediate region may only partially surround, coat, cover, or enclose a chewing gum or confectionery base.

The selection of the form of the intermediate region composition may depend on the desired texture of the confectionery composition.

In some embodiments, the intermediate region composition may include one or more sweeteners, and/or one or more flavors, and/or one or more sensates, and/or one or more salts, and/or one or more functional ingredients, and/or one or more food acids, each of which are described in detail above. In some embodiments, the one or more sweeteners, and/or one or more flavors, and/or one or more sensates, and/or one or more functional ingredients, and/or one or more food acids may be encapsulated, unencapsulated (or “free”) or a combination of encapsulated and unencapsulated.

In embodiments where the intermediate region composition is in crystalline or amorphous form, the intermediate region may be created by any conventional method known in the art. Such methods may include, but are not limited to, hard panning, soft panning, enrobing, spray coating, lamination, co-extrusion, multiple-extrusion, drum sanding, thin film depositing, and the like. As with the particulate coating compositions, crystalline or amorphous intermediate region compositions may include sweeteners and food acids and may be created to provide sour taste intensities equivalent to 0.2% w/w solution of citric and/or a sour taste intensity of at least 4 on a scale from 0 to 10.

In some embodiments, the intermediate region composition may be included in the confectionery composition in amounts from about 1 percent by weight of the total composition to about 75 percent of the total composition. In some embodiments, the intermediate region composition may be included in the sanded confectionery composition in amounts from about 5 percent by weight of the total composition to about 20 percent by weight of the total composition.

### Sensate-Plated Sanded Center-Fill Gummy Candy Composition

In some embodiments, a multi-region confection can include center-filled gummy candy confectionery products. The moisture content of a center-filled gummy candy can be greater than the moisture content of a gummy candy without a center-filling. In some embodiments, the higher moisture content of a center-filled gummy candy creates a need for a sanding composition that will not pull moisture out of the gummy candy. In some embodiments, a sanding composition can be in a particulate form that at least partially covers the center-filled gummy candy. In some embodiments, partially or completely encapsulating an ingredient used in a confectionery composition with an encapsulating material may stabilize the ingredient against moisture absorption and/or moisture migration.

In some embodiments, pectin and gelatin may be used together in a gummy candy composition as described in U.S. application Ser. No. 10/977,585, filed Oct. 28, 2004 and incorporated herein for all purposes. This combination of hydrocolloids may create a gummy candy shell that sets up quickly and provides adequate shell strength and desirable texture.

In some embodiments, the gummy candy shell composition may contain sweeteners in amounts from about 35% w/w to about 75% w/w of the gummy candy shell composition. In some embodiments, the gummy candy shell composition may contain from about 0.01% w/w to about 15% w/w, and preferably from about 1% to about 8% w/w of hydrocolloids. In some embodiments, the gummy candy composition may contain from about 0.3% to about 3%, and preferably from about 0.5% w/w and about 2.0% w/w food acids.

As with the center-fill composition, in some embodiments, the gummy candy composition can also include buffering agents, coloring, flavoring, and preservatives.

Further, in some embodiments, the gummy candy shell composition can include any functional ingredients as discussed above.

In multi-region confectionery compositions, there is a natural tendency for moisture to migrate from areas of higher concentration to areas of lower concentration. This can result in multi-region confectionery compositions that lack desired textures as the textures can lose their differentiation as the moisture equilibrates. For example, if the gummy candy shell composition has less moisture than the center-fill composition, the moisture will migrate out of the center-fill causing the center-fill to become firmer resulting in a center-fill texture that is similar to the gummy candy shell texture. Similarly, if the sanding composition is more hygroscopic than the gummy candy shell composition, the sanding will pull moisture out of the shell resulting in a less crispy or friable coating or a coating that appears and feels “wet” i.e. not dry. In some embodiments, hygroscopic ingredients can be encapsulated to reduce their moisture pick up.

In some embodiments, the solids content of the center-fill composition and the gummy candy shell composition are similar and are from about 10% w/w to about 85% w/w of the individual composition. In some embodiments, the solids content of the center-fill composition is equal to the solids content of the gummy candy shell composition. In still other embodiments, the solids content of the center-fill composition is less than or equal to the solids content of the gummy candy shell composition. Solids content may be measured by any conventional means including methods that provide a Brix value such as by using a refractometer.

In addition to manipulation of the solids content of the center-fill composition and the gummy candy shell composition, moisture migration can be managed by controlling the amount of bound water in the compositions.

The amount of bound water in a food product can be expressed as the water activity (a_{w}). Water activity can be measured by any conventional means known to those of skill in the art and is expressed in amounts ranging from 0.00 to 1.00. In some embodiments, the water activity of the center-fill composition is substantially similar to the water activity of the gummy candy shell composition and can be in the range from about 0.5 to about 0.8. In some embodiments, the water activity of the center-fill composition is equal to the water activity of the gummy candy shell composition. In still other embodiments, the water activity of the center-fill composition is less than the water activity of the gummy candy shell composition.

Due to the multiple regions included in the sensate-plated sanded center-filled gummy candy, it is possible to modify the composition of the individual regions to achieve a desired effect. For example, the sanding composition may be formulated to provide a cooling perception while the gummy shell and center-fill may be formulated to provide a warming perception. Upon consumption, a sour taste followed by a sweet taste may be perceived. In some embodiments, different flavors may be included in the different regions to provide a contrasting flavor perception or a blended flavor perception. In other embodiments, ingredients that are not compatible with each other may be placed in different regions to avoid undesirable interactions.

Sensate-plated sanded center-filled gummy candy compositions can be created using any conventional method known to those of ordinary skill in the art. The center-fill composition can be prepared by mixing the individual ingredients together with conventional mixing equipment such as batch cookers, scraped surface mixers, and the like. In some embodiments, hydrocolloid materials may be hydrated prior to addition to the center-fill composition. In other embodiments, the mixed center-fill composition is heat treated to adjust the solids content to a desired level. In some embodiments, the mixture is heated to a final temperature of 215° F. to 235° F.

The gummy candy shell composition can be prepared by hydrating the hydrocolloids prior to addition to the sweetener(s). In some embodiments, the hydrocolloids can be dry blended with other solids to facilitate hydration. Once the hydrocolloid material is mixed into the sweetener(s), the mixture is heat treated to adjust the solids content to a desired level. In some embodiments, the mixture is heated to a cook temperature from about 200 F to about 300 F, preferably from about 250 F to about 275 F. In other embodiments, vacuum cooking may be used.

In some embodiments, the center-filled gummy candy is created by co-depositing using a depositing nozzle with concentric design elements that allow the gummy candy shell to be deposited into a mold prior to depositing of the center-fill. This concentric design can create a piece that includes a center-fill inside a gummy candy shell. In some embodiments, the temperature of the center-fill mixture being fed into the co-depositor and the temperature of the gummy candy shell mixture being fed into the co-depositor are not the same. In some embodiments, the temperature of the center-fill is less than the temperature of the gummy candy shell mixture. In other embodiments, the temperature of the center-fill mixture is from about 70 F to about 90 F and the temperature of the gummy candy shell mixture is from about 180 F to about 210 F.

In some embodiments, the co-depositor feeds the center-fill mixture and the gummy candy shell mixture into starch molds. Examples of processing equipment that can perform these operations are available from manufacturers such as NID and Mogul.

The sensate-plated sanding composition can be applied to the confectionery or chewing gum by any conventional means known to those of ordinary skill in the art. In some embodiments, the sensate-plated sanding composition including free and/or encapsulated ingredients is in particulate form and the center-filled gummy candy is subjected to a brief steam treatment prior to applying the coating. The wetted surface of the steam treated center-filled gummy candy can cause the particulate coating composition including free and/or encapsulated ingredients to adhere to the surface. Alternatively, a wetting syrup including carbohydrates such as sweeteners and/or hydrocolloids can be applied to the surface of the center-filled gummy candy to cause the particulate coating including free and/or encapsulated ingredients to adhere to the surface.

### EXAMPLES

### Example 1

### Sensate-Plated Sanding Composition

The sensate-plated sanding composition is prepared by combining the components as set forth in Examples A-E in Table 1. The amounts included are based on the weight percent of the total sensate-plated sanding composition.

TABLE 1
Sensate-Plated Sanding Composition

| | % by weight | | | | |
|---|---|---|---|---|---|
| Components | A | B | C | D | E |
| Saccharides | | | | | |
| Sugar | 95.00-99.99 | | 80.00-94.99 | 80.00-94.99 | 80.00-89.99 |
| Polyol | | 50.00-95.00 | | | |
| Maltodextrin | | | 1.00-5.00 | | |
| Food Acid | | | | | 5.00-15.00 |
| Sensate | 0.01-5.00 | 0.01-5.00 | 0.01-10.00 | 0.01-15.00 | 0.01-5.00 |
| Silicate | | | | 0.01-5.00 | |

### Example 2

### Sensate-Plated Sanded Confectionery Composition

The sensate-plated sanded gummy candy composition is prepared by combining the components as set forth in Examples F-I in Table 2. The amounts are based on the weight percent of the total gummy candy composition.

TABLE 2
Gummy Candy Confectionery Base Composition

| | % by weight | | | |
|---|---|---|---|---|
| Components | F | G | H | I |
| Corn Syrup | | | 18.00-22.00 | 19.00-20.00 |
| Starch | 9.00-12.00 | 10.00-10.50 | 9.00-12.00 | 10.00-10.50 |
| Invert Sugar | | | 18.00-22.00 | 19.50-20.50 |
| Sugar | | | 35.00-39.00 | 36.50-37.50 |
| Polyol | 71-83 | 75-78 | | |
| Water | q.s. | q.s. | q.s. | q.s. |
| Flavor | 0.00-2.00 | 0.00-2.00 | 0.00-1.00 | 0.00-2.00 |
| Color | 0.00-2.00 | 0.00-2.00 | 0.00-1.00 | 0.00-2.00 |

Any of the sensate-plated sanding compositions of Examples A-E are applied to the exterior of any of the gummy candy confectionery compositions described in Examples F-I. The confectionery base composition is present in an amount from about 70% by weight to about 90% by weight of the total composition and the sanding composition is added in an amount from about 5% by weight to about 15% by weight of the total composition.

### Example 3

### Sensate-Plated Sanded Chewing Gum Composition

The sensate-plated sanded chewing gum composition is prepared by combining the components as set forth in Examples J-M in Table 3. The amounts are based on the weight percent of the total gummy candy composition.

TABLE 3
Chewing Gum Confectionery Base Composition

| | % by weight | | | |
|---|---|---|---|---|
| Components | J | K | L | M |
| Chewing Gum | 28-42 | 28-42 | 28-42 | 28-42 |
| Base* | | | | |
| Lecithin | 0.01-0.50 | 0.05-0.25 | 0.01-0.50 | 0.05-0.25 |
| Polyol | 35.00-39.00 | 36.50-37.50 | | |
| Sugar | | | 35.00-39.00 | 36.50-37.50 |
| Corn syrup | | | q.s. | q.s. |
| Polyol syrup | q.s. | q.s. | q.s. | q.s. |
| Flavor | 0.00-5.00 | 0.00-2.50 | 0.00-5.00 | 0.00-2.50 |
| Color | 0.00-2.00 | 0.00-2.00 | 0.00-1.00 | 0.00-2.00 |

*chewing gum base may include 3% to 11% by weight of a filler such as, for example, talc, dicalcium phosphate, and calcium carbonate (the amount of filler in the chewing gum base is based on the weight percent of the chewing gum region composition, for example, in the above compositions J-M, if a chewing gum region composition includes 5% filler, the amount of chewing gum base will be 5% less than the range recited in the table, i.e., from 23-37%)

Any of the sensate-plated sanding compositions of Examples A-E are applied to the exterior of any of the chewing gum compositions described in Examples J-M. The chewing gum composition is present in an amount from about 70% by weight to about 95% by weight of the total composition and the sanding composition is added in an amount from about 5% by weight to about 15% by weight of the total composition.

### Example 4

### Sensate-Plated Sanded Center-Fill Confectionery Composition

The sensate-plated sanded center-fill gummy candy composition is prepared by combining the sensate-plated sanding composition with a center-fill confectionery base composition.

The center-fill composition is prepared by combining the components as set forth in Examples N-Q in Table 4. The amounts included are based on the weight percent of the total center-fill composition.

TABLE 4
Center-fill Composition

| | % by weight | | | |
|---|---|---|---|---|
| Components | N | O | P | Q |
| Sugar | 42-48 | 42-48 | | |
| Corn Syrup | 42-48 | 42-48 | | |
| Polyol (syrup or slurry) | | | 84-96 | 84-96 |
| Guar Gum | 0.1-0.7 | | 0.1-0.7 | |
| Citric Acid | 0.7-4.5 | 0.7-4.5 | 0.7-4.5 | 0.7-4.5 |
| Flavor | 0.05-.30 | 0.05-.30 | 0.05-.30 | 0.05-.30 |
| Color | 0.1-0.7 | 0.1-0.7 | 0.1-0.7 | 0.1-0.7 |

The gummy candy shell composition is prepared by combining the components as set forth in Examples R-W in Table 5. The amounts included are based on the weight percent of the total gummy candy shell composition.

TABLE 5
Gummy Candy Shell Composition

| | % by weight | | | | | |
|---|---|---|---|---|---|---|
| Components | R | S | T | U | V | W |
| Sugar | 15-25 | 15-25 | | | 20-35 | |
| Corn Syrup | 30-45 | 30-45 | | | 20-35 | |
| Sweetener | | | | | | |
| Citric Acid | 0.5-1.5 | 0.5-1.5 | 0.5-1.5 | 0.5-1.5 | 0.5-1.5 | 0.5-1.5 |
| Gelatin | 7-12 | | 7-12 | | | 7-12 |
| Pectin | 0.8-1.5 | | 0.8-0.5 | | | 0.8-1.5 |
| Carrageenan | | 1.5-3.0 | | 1.5-3.0 | 1.5-3.0 | |
| Color | 0.1-0.7 | 0.1-0.7 | 0.1-0.7 | 0.1-0.7 | 0.1-0.7 | 0.1-0.7 |
| Flavor | 0.05-0.30 | 0.05-0.30 | 0.05-0.30 | 0.05-0.30 | 0.05-0.30 | 0.05-0.30 |

Any of the center-fill compositions of Examples N-Q may be incorporated into any of the gummy candy shell compositions of R-W and then any of the sensate-plated sanding compositions of Examples A-E may be applied to the exterior. The center-fill is added in an amount from about 5% by weight to about 25% by weight of the total composition. The gummy candy shell is added in an amount from about 70% by weight to about 90% by weight of the total composition and the coating is added in an amount from about 5% by weight to about 15% by weight of the total composition.

Optionally, an aqueous wetting syrup is prepared by combining components set forth in Examples X and Y in Table 6. The amounts are based on weight percent of the total aqueous wetting syrup composition.

TABLE 6
Aqueous Wetting Syrups

% by weight

| Components | X | Y |
|---|---|---|
| Dextrin | 5-30 | |
| Sugar | 20-60 | 20-60 |
| Water | 20-60 | 20-60 |
| Water-based Shellac | | 5-60 |
| Hydrocolloid | | 0.01-5 |

The aqueous wetting syrup of Example X is prepared by heating the water to at least 35° C., then adding the dextrin and sugar to the water. The temperature is maintained at about 35° C. and the combination of dextrin, sugar and water is mixed until homogenous, creating the wetting syrup. The wetting syrup is then applied to the surface of the confectionery composition by atomized spray. In alternative methods, the syrup may be applied by enrobing based methods, tumbling, dipping and/or painting. The wetted confectionery composition is then dried under ambient or drying conditions until the surface of the wetted confectionery composition reaches a desired tackiness. A sensate-plated sanding composition as described above is then applied to the surface of the wetted confectionery. The sensate-plated sanded confectionery composition is then dried and packaged.

The aqueous wetting syrup of Example Y is prepared by heating the water to about 20° C.-80° C., then adding the water-based shellac, sugar and hydrocolloid. The combination of water-based shellac, sugar, hydrocolloid and water is mixed until homogenous, creating the wetting syrup. The wetting syrup is then applied to the surface of the confectionery composition by atomized spray. In alternative methods, the syrup may be applied by enrobing based methods, tumbling, dipping and/or painting. The wetted confectionery composition is then dried under ambient or drying conditions until the surface of the wetted confectionery composition reaches a desired tackiness. A sensate-plated sanding composition as described above is then applied to the surface of the wetted confectionery. The sanded confectionery composition is then dried and packaged.

The aqueous wetting syrups described herein may be optionally applied to any of the confectionery compositions described above.

The non-aqueous wetting syrup is prepared by combining components set forth in Examples Z-CC in Table 7. The amounts are based on weight percent of the total non-aqueous wetting syrup composition.

TABLE 7
Non-Aqueous Wetting Syrups

% by weight

| Components | Z | AA | BB | CC |
|---|---|---|---|---|
| Resin | 5-40% | 0 | 0-20% | 0 |
| Fat | 0 | 0-40% | 0-20% | 0-100% |
| Wax | 0 | 0-40% | 0-20% | 0-100% |
| Liquid oil | 60-90% | 0-60% | 0-40% | 0 |
| Water | 0-5% | 0 | 0 | 0 |

The non-aqueous wetting syrups of Examples Z-CC are prepared by heating the ingredient having the largest % by weight to at least 35° C., then adding the remaining ingredients to the ingredient having the largest % by weight. The temperature is maintained at about 35° C. and the combination mixed until homogenous, creating the wetting syrup. The wetting syrup is applied to the surface of the confectionery composition by atomized spray. In alternative methods, the wetting syrup may be applied by enrobing based methods, tumbling, dipping and/or painting. The wetted confectionery composition is then dried under ambient or drying conditions until the surface of the wetted confectionery composition reaches a desired tackiness. A sensate-plated sanding composition as described above is then applied to the surface of the wetted confectionery. The sensate-plated sanded confectionery composition is then dried and packaged.

A solvent based shellac is also used as a wetting syrup. The wetting syrup is applied to the surface of the confectionery composition by atomized spray. In alternative methods, the wetting syrup may be applied by enrobing based methods, tumbling, dipping and/or painting. The wetted confectionery composition is then dried under ambient or drying conditions until the surface of the wetted confectionery composition reaches a desired tackiness. A sensate-plated sanding composition as described above is then applied to the surface of the wetted confectionery. The sensate-plated sanded confectionery composition is then dried and packaged.

The non-aqueous wetting syrups described herein may be optionally applied to any of the confectionery compositions described above.

1. A sensate-plated sanding composition comprising:
a saccharide particulate plated with a liquid sensate composition.

2. The composition of claim 1, wherein said liquid sensate composition comprises a sensate composition selected from the group consisting of cooling agents, warming agents, tingling agents, and combinations thereof

3. The composition of claim 1, wherein said liquid sensate composition comprises a cooling composition.

4. The composition of claim 3, wherein said cooling composition includes cooling agents selected from the group consisting of menthane, menthone, ketals, menthone ketals, menthone glycerol ketals, substituted p-menthanes, acyclic carboxamides, cyclic carboxamides, mono menthyl glutarate, mono menthyl succinate, substituted cyclohexanamides, substituted cyclohexane carboxamides, substituted ureas and sulfonamides, substituted menthanols, hydroxymethyl and hydroxymethyl derivatives of p-menthane, 2-mercapto-cyclo-decanone, hydroxycarboxylic acids with 2-6 carbon atoms, cyclohexanamides, menthyl acetate, menthyl salicylate, N,2,3-trimethyl-2-isopropyl butanamide, N-ethyl-p-menthane-3-carboxamide, isopulegol, 3-(1-menthoxy)propane-1,2-diol, 3-(1-menthoxy)-2-methylpropane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, Japanese mint oil, peppermint oil, 3-(1-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol, N-(4-cyanomethylphenyl)-p-menthanecarboxamide, menthone glycerol ketals; 3-1-menthoxypropane-1,2-diol and menthyl lactate and combinations thereof.

5. The composition of claim 1, wherein said liquid sensate composition comprises a warming composition.

6. The composition of claim 1, wherein said liquid sensate composition comprises a tingling composition.

7. The composition of claim 1, wherein said sensate-plated sanding composition further includes a flavor or functional ingredient.

8. The composition of claim 1, wherein said liquid sensate composition is present in amount of 0.01 to 15% by weight of said sensate-plated sanding composition.

9. The composition of claim 1, wherein said sensate-plated sanding composition comprises a sorption aid.

10. The composition of claim 9, wherein said sorption aid is selected from the group consisting of maltodextrins, silicates, celluloses, starches, gum arabics, silicas, zeolites, and combinations thereof.

11. The composition of claim 9, wherein said liquid sensate composition is present in amount of 0.01 to 20.0% by weight of said sensate-plated sanding composition.

12. The composition of claim 1, wherein said saccharide particulate is selected from the group consisting of polyols, sugars, polysaccharides, and combinations thereof.

13. The composition of claim 1, wherein said sensate-plated sanding composition comprises a particulate food acid.

14. The composition of claim 1, wherein said sensate-plated sanding composition comprises an acid blend comprising food acids selected from the group consisting of citric acid, malic acid, lactic acid, tartaric acid, ascorbic acid and combinations thereof.

15. A multi-region confectionery composition comprising:
a first region comprising a confectionery base; and
a second region comprising a sensate-plated sanding composition including a saccharide particulate and a liquid sensate composition associated with said saccharide particulate;
wherein said second region at least partially surrounds said first region.

16. The composition of claim 15, wherein said liquid sensate composition is plated onto a surface of said sensate-plated sanding composition.

17. The composition of claim 15, wherein said liquid sensate composition is sorbed onto a surface of said sensate-plated sanding composition.

18. The composition of claim 15, wherein said liquid sensate composition comprises a sensate composition selected from the group consisting of cooling agents, warming agents, tingling agents, and combinations thereof.

19. The composition of claim 15, wherein said liquid sensate composition comprises a cooling composition.

20. The composition of claim 19, wherein said cooling composition includes cooling agents selected from the group consisting of menthane, menthone, ketals, menthone ketals, menthone glycerol ketals, substituted p-menthanes, acyclic carboxamides, cyclic carboxamides, mono menthyl glutarate, mono menthyl succinate, substituted cyclohexanamides, substituted cyclohexane carboxamides, substituted ureas and sulfonamides, substituted menthanols, hydroxymethyl and hydroxymethyl derivatives of p-menthane, 2-mercapto-cyclo-decanone, hydroxycarboxylic acids with 2-6 carbon atoms, cyclohexanamides, menthyl acetate, menthyl salicylate, N,2,3-trimethyl-2-isopropyl butanamide, N-ethyl-p-menthane-3-carboxamide, isopulegol, 3-(1-menthoxy)propane-1,2-diol, 3-(1-menthoxy)-2-methylpropane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, Japanese mint oil, peppermint oil, 3-(1-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol, N-(4-cyanomethylphenyl)-p-menthanecarboxamide, menthone glycerol ketals; 3-1-menthoxypropane-1,2-diol and menthyl lactate and combinations thereof.

21. The composition of claim 15, wherein said liquid sensate composition comprises a warming composition.

22. The composition of claim 15, wherein said liquid sensate composition comprises a tingling composition.

23. The composition of claim 15, wherein said sensate-plated sanding composition further includes a flavor or functional ingredient.

24. The composition of claim 15, wherein said liquid sensate composition is present in amount of 0.01 to 15% by weight of said sensate-plated sanding composition.

25. The composition of claim 15, wherein said sensate-plated sanding composition comprises a sorption aid.

26. The composition of claim 25, wherein said sorption aid is selected from the group consisting of maltodextrins, silicates, celluloses, starches, gum arabics, silicas, zeolites, and combinations thereof.

27. The composition of claim 25, wherein said liquid sensate composition is present in amount of 0.01 to 20.0% by weight of said sensate-plated sanding composition.

28. The composition of 15, wherein said confectionery base composition is selected from the group consisting of chewy candy, gummy candy, marshmallow, chewing gum, and combinations thereof.

29. The composition of claim 15, wherein said saccharide particulate is selected from the group consisting of polyols, sugars, polysaccharides, and combinations thereof.

30. The composition of claim 15, wherein said sensate-plated sanding composition is present in amount of 3% to about 20% by weight of said multi-region confectionery composition.

31. The composition of claim 15, wherein said sensate-plated sanding composition is present in amount of 7% to about 15% by weight of said multi-region confectionery composition.

32. The composition of claim 15, wherein said first region further comprises a sensate composition selected from the group consisting of cooling agents, warming agents, tingling agents, and combinations thereof.

33. The composition of claim 32, wherein said cooling agent is selected from the group consisting of menthane, menthone, ketals, menthone ketals, menthone glycerol ketals, substituted p-menthanes, acyclic carboxamides, cyclic carboxamides, mono menthyl glutarate, mono menthyl succinate, substituted cyclohexanamides, substituted cyclohexane carboxamides, substituted ureas and sulfonamides, substituted menthanols, hydroxymethyl and hydroxymethyl derivatives of p-menthane, 2-mercapto-cyclo-decanone, hydroxycarboxylic acids with 2-6 carbon atoms, cyclohexanamides, menthyl acetate, menthyl salicylate, N,2,3-trimethyl-2-isopropyl butanamide, N-ethyl-p-menthane-3-carboxamide, isopulegol, 3-(1-menthoxy)propane-1,2-diol, 3-(1-menthoxy)-2-methylpropane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, Japanese mint oil, peppermint oil, 3-(1-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol, N-(4-cyanomethylphenyl)-p-menthanecarboxamide, menthone glycerol ketals; 3-1-menthoxypropane-1,2-diol and menthyl lactate and combinations thereof.

34. The composition of claim 15, wherein said first region is in a ratio of between 4:1 to 50:1 with said second region.

35. The composition of claim 15, wherein said multi-region confectionery composition further comprises a third region, wherein said third region is at least partially surrounded by said first region.

36. The composition of claim 15, wherein said sensate-plated sanding composition comprises an acid blend comprising food acids selected from the group consisting of citric acid, malic acid, lactic acid, tartaric acid, ascorbic acid and combinations thereof.

37. The composition of claim 15, further comprising a wetting syrup at least partially surrounding said first region.

38. The composition of claim 37, wherein said wetting syrup is selected from the group consisting of aqueous wetting syrups, non-aqueous wetting syrups, and combinations thereof.

39. The composition of claim 37, wherein said wetting syrup comprises a flavor.

40. The composition of claim 39, wherein said flavor comprises a sensate composition selected from the group consisting of cooling agents, warming agents, tingling agents, and combinations thereof.

41. The composition of claim 37, wherein said wetting syrup comprises a color.

42. A method of making a sensate-plated sanded confectionery composition comprising the steps of
a. providing a confectionery base composition having an outer surface;
b. providing a sensate-plated sanding composition;
c. steaming said outer surface of said confectionery base composition; and
d. applying said sensate-plated sanding composition to said outer surface of said confectionery base composition.

43. The method of claim 42, wherein said confectionery base composition is selected from the group consisting of chewy candy, gummy candy, marshmallow, chewing gum, and combinations thereof.

44. The method of claim 42, wherein said sensate-plated sanding composition is formed by adding a liquid sensate composition to a particulate blend.

45. The method of claim 44, wherein said particulate blend comprises ingredients selected from the group consisting of saccharides, food acids, flavors, and combinations thereof.

46. The composition of claim 42, wherein said sensate-plated sanding composition comprises a sorption aid.

47. The composition of claim 46, wherein said sorption aid is selected from the group consisting of maltodextrins, silicates, celluloses, starches, gum arabics, silicas, zeolites, and combinations thereof.

48. The method of claim 42, wherein said sensate-plated sanding composition comprises a sensate composition selected from the group consisting of cooling agents, warming agents, tingling agents, and combinations thereof.

49. The method of claim 48, wherein said sensate composition comprises a cooling agent.

50. A method of preparing a coated confectionery product comprising the steps of
(a) applying a liquid wetting syrup to a surface of a confectionery base composition to form a wetted confectionery composition;
(b) forming a tacky exterior surface on the wetted confectionery composition by drying or removing at least a portion of the liquid from the confectionery surface;
(c) applying a sensate-plated sanding composition to said tacky exterior surface to form a sensate-plated sanded confectionery composition;
(e) further drying said sensate-plated sanded confectionery composition; and
(f) packaging said dried sensate-plated sanded confectionery composition.

51. The method of claim 50, wherein said sensate-plated sanding composition is formed by adding a liquid sensate composition to a particulate blend.

52. The method of claim 51, wherein said particulate blend comprises ingredients selected from the group consisting of saccharides, food acids, flavors, and combinations thereof.

53. The method of claim 50, wherein said sensate-plated sanding composition comprises a sensate composition selected from the group consisting of cooling agents, warming agents, tingling agents, and combinations thereof.

54. The method of claim 50, wherein said liquid wetting syrup is selected from the group consisting of aqueous wetting syrups, non-aqueous wetting syrups, and combinations thereof.

55. The method of claim 50, wherein said liquid wetting syrup comprises a flavor.

56. The method of claim 50, wherein said liquid wetting syrup comprises a color.
